(19) United States
(12) Patent Application Publication
(10) Pub. No.: US 2006/0285356 A1
(43) Pub. Date: Dec. 21, 2006

(54) Side-edge backlight module dimming pack

(75) Inventor: Wen-Pao Tseng, Yangmei Taoyuan (TW)

Correspondence Address: TROXELL LAW OFFICE PLLC;SUITE 1404, 5205 LEESBURG PIKE, FALLS CHURCH, VA, 22041, US

(73) Assignee: K-Bridge Electronics Co., Ltd.

(21) Appl. No.: 11/156,730

(22) Filed: Jun. 21, 2005

(51) Int. Cl. F21V 5/02

(52) U.S. Cl. 362/608; 362/613

(57) ABSTRACT

A side-edge backlight dimming pack includes a light source in a shade, a light guide plate disposed at the opening of the shade; light being emitted to and reflected by the light guide plate to a plate surface intended to display the light source; a dimming pack disposed between the light source and the light guide plate including a light inlet surface and a light outlet surface with each surface provided with multiple diffusers for the light to be diffused at least twice through the diffusers before entering into the light guide plate to achieve more effective use of the light.

### BACKGROUND OF THE INVENTION

(a) Field of the Invention

The present invention is related to a dimming pack, and more particularly, to one of a side-edge backlight module.

(b) Description of the Prior Art

When applied in an IT device, a direct type or a side-edge backlight module is generally selected depending on the design requirements. As illustrated in FIG. 1 of the accompanying drawing for a schematic view of a basic structure of a configuration of an edge-side backlight module. It is essentially comprised of a shade 10 containing a light source 20, and a light guide plate 30 having its one end inserted to an operating of the shade 10 while multiple optical films 50 and a display panel 60 are disposed in sequence above the light guide plate 30 to permit the light form the light source 20 to be emitted into the light guide plate and reflected towards a plate surface designated by the light guide plate to achieve the purpose of light source display.

However, once the light projected in the direction where the light is emitted from the light source enters into the light guide plate 30, a collective irradiation of the light takes place on the light guide plate 30 at where closer to the light source to create a band of bright stripe thus to affect the quality of picture on the LCD.

### SUMMARY OF THE INVENTION

The primary purpose of the present invention is to provide a dimming pack for a side-edge backlight module to solve the problem of many flaws of the prior art that develops band of bright stripe at the light source to affect the quality of the picture on the LCD. To achieve the purpose, a dimming pack is disposed between the light source and the light guide plate. A light inlet surface is disposed exactly at where aligned at the source and a light outlet surface is provided at one end of the light guide plate with both surfaces disposed with multiple diffusers so that the light form the light source before entering into the light guide plate is diffused at least twice be those diffusers of the dimming pack for more effective use of the light.

### BRIEF DESCRIPTION OF THE DRAWINGS

FIG. 1 is a schematic view showing the structure of a side-edge backlight module of the prior art.

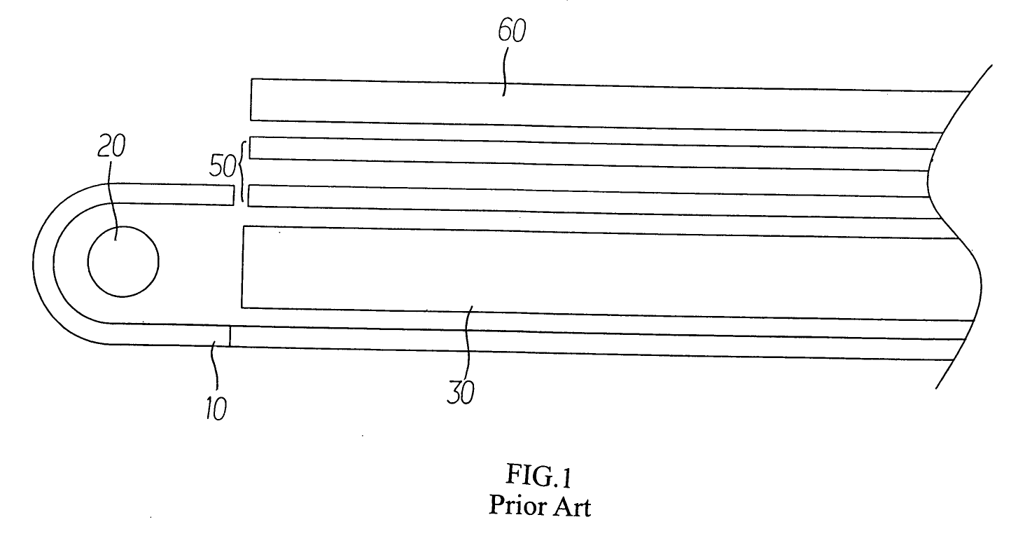

FIG. 2 is a schematic view showing the adaptation of a dimming pack of a side-edge backlight module of the present invention.

FIG. 3 is a perspective view of the structure of a dimming pack of the present invention.

FIG. 4 is a perspective view of the structure of another dimming pack of the present invention.

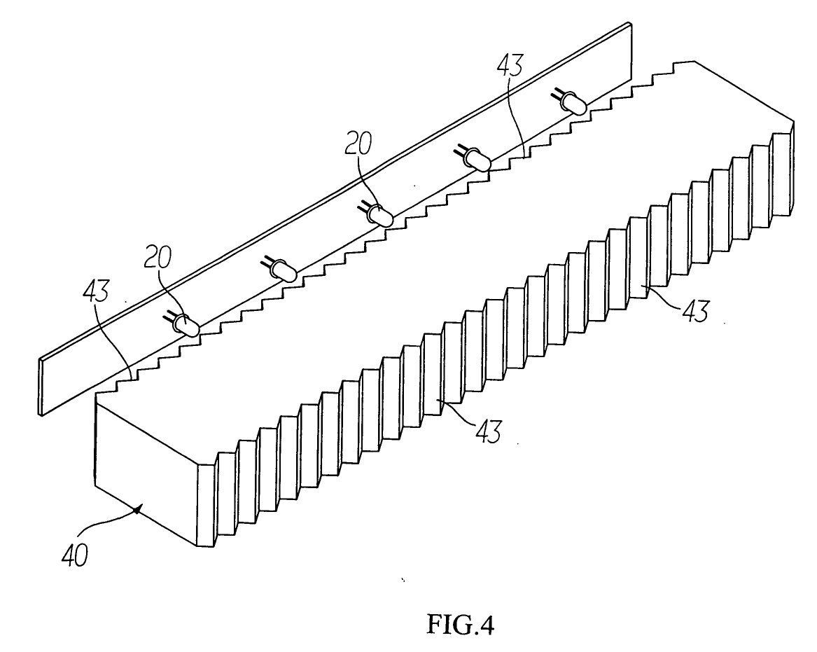

FIG. 5 is a perspective view showing a hollow member is disposed in the dimming pack of the present invention.

FIG. 6 is a perspective view showing another hollow member disposed in the dimming pack of the present invention.

FIG. 7 is a schematic view showing the structure of multiple diffusers adapted to the side-edge backlight module of the present invention.

### DETAILED DESCRIPTION OF THE PREFERRED EMBODIMENTS

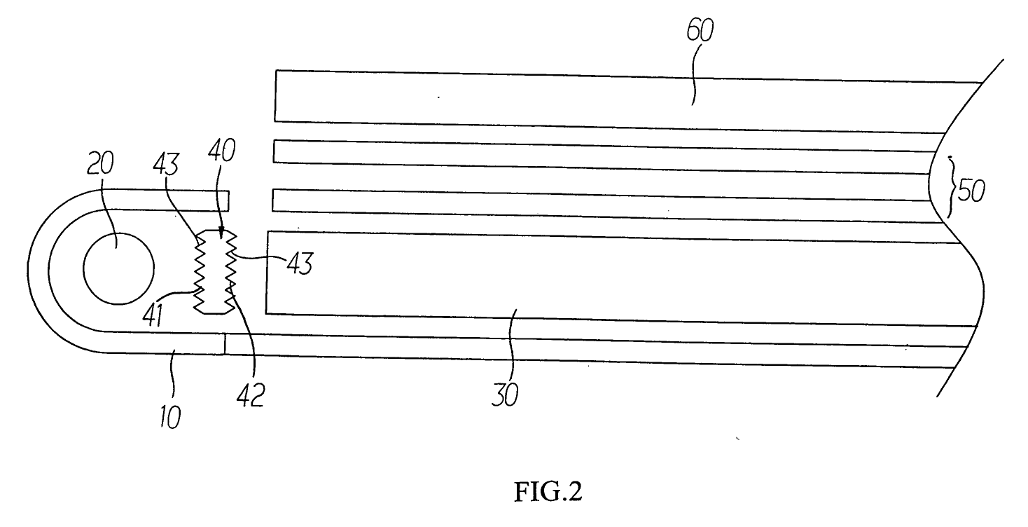

Referring to FIG. 2 for a basic structure and assembly of a dimming pack for a side-edge backlight module in a preferred embodiment of the present invention, a shade 10 contains a light source 20, a light guide plate 30 having its end inserted to an opening of the shade 10 to admit the light form the light source 20 to be emitted into the light guide plate 30 from its end and reflected from the light guide plate 30 to a plate surface as designated by the light guide plate to display the light from the light source similar to that of the prior art. In the preferred embodiment of the present invention, a dimming pack 40 is disposed between the light source 20 and the light guide plate 30. A light inlet surface 41 is disposed on the dimming pack 40 at where exactly aligned at the light source, and a light outlet surface is disposed at one end of the light guide plate 30. Multiple optical films 50 comprised of the combination of 1˜3 diffuser, 0˜2 brightness enhancing film (BEF), 0˜1 reflective polarizer as applicable are disposed over the light guide plate 30. A display panel 60 is disposed over those multiple optical films so to project the light towards those multiple optical films 50 in the direction of the display panel 60.

Whereas the light outlet surface of the dimming structure 40 is exactly aligned at one end of the light guide plate 30, the light from the light source enters into the dimming pack 40 from the light inlet surface 41 leaves the light outlet surface 42 and enters into the light guide plate 30 for the side-edge backlight module to produce the luminance as expected for display.

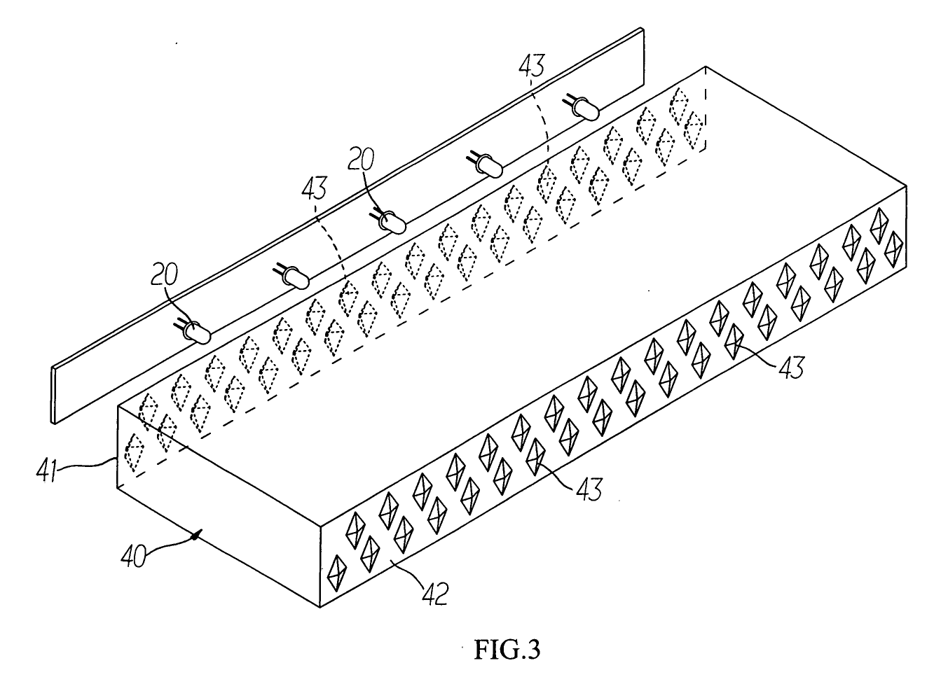

As illustrated in FIGS. 2 and 3, multiple diffusers 43 are disposed on the dimming pack at where the light from the light source 20 passes through (i.e., on the light inlet surface 41 and the light outlet surface as illustrated). Each diffuser 43 may be comprised of multiple protrusions or pits (not illustrated) each in a form of polygonal awl, or having such protrusion or pit directly extending from the diffuser in the same geometric form or in various geometric forms; or alternatively, the diffuser 43 may be comprised of multiple slots each in a form of straight line as long as it diffuses the light passing through it.

Accordingly, before the light form the light source 20 entering into the light guide plate 30, it travels in a route that has to first pass through the dimming pack 40 to undergo diffusion and mixing at lease twice for achieving more effective use of the light and alleviating the significant distinction of intermittent bands of bright and dark stripes.

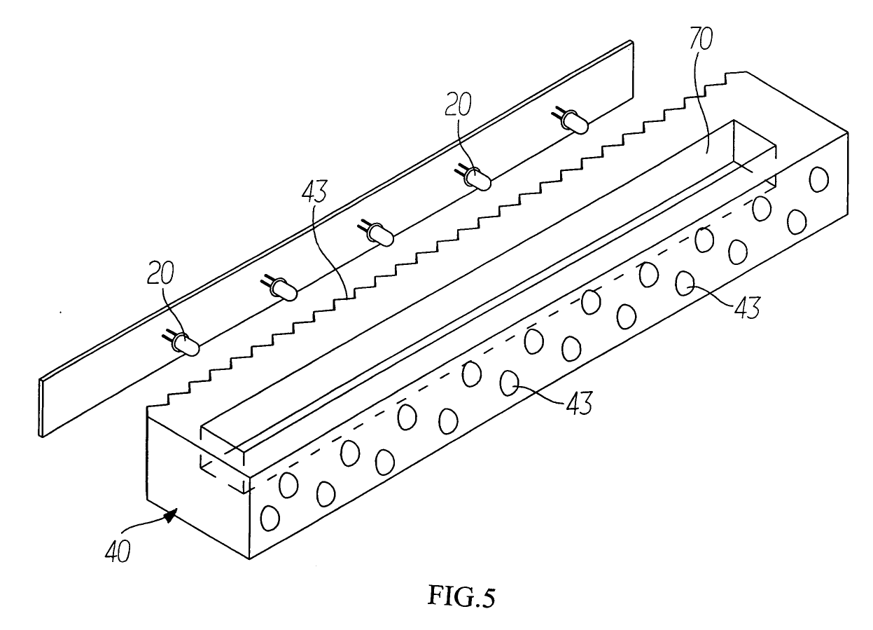

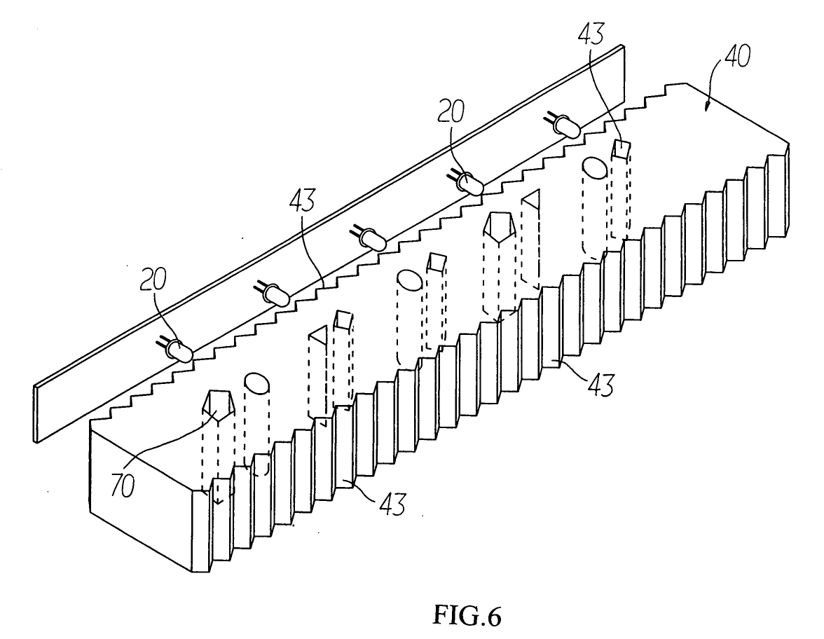

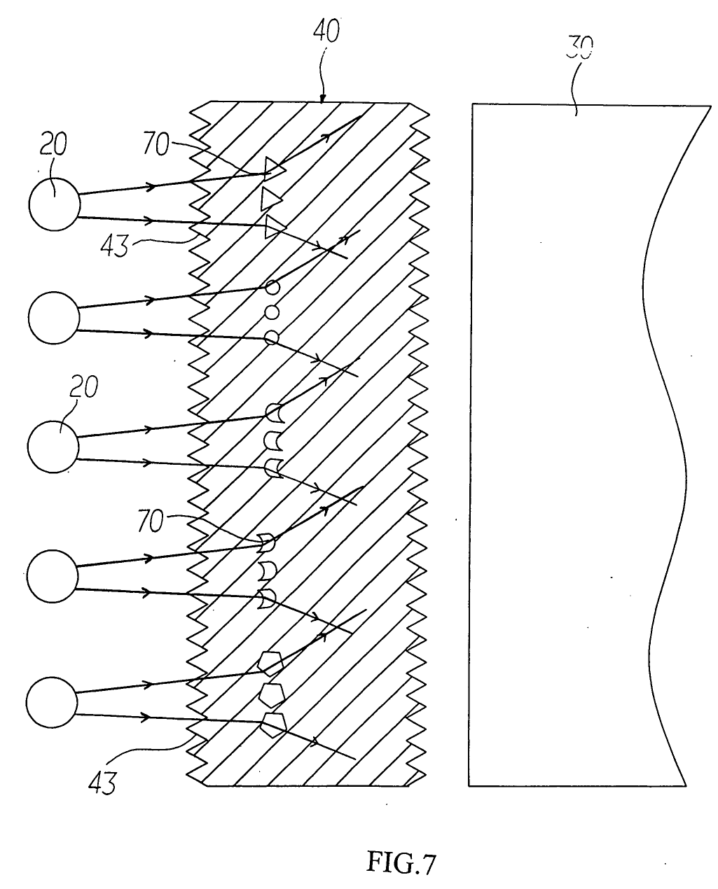

Multiple hollow members 70 are further disposed in the dimming pack 40 to enhance the diffusion results. As illustrated in FIG. 5, those hollow members are arranged in continuous form, or as illustrated in FIG. 6, not in continuous form. Either arrangement provides the same diffusion for the light passing through the dimming pack 40 as illustrated in FIG. 7

The prevent invention provides a dimming pack for the conventional side-edge backlight module, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. A dimming pack of a side-edge backlight module is provided at where between a light source and a light guide plate; the light source being contained in a shade, one end of the light guide plate being inserted to an opening of the shade; the light from the light source being emitted form one end of the light guide plate and reflected towards a plate surface designated by the light guide plate to achieve the display results for the light source; a light inlet surface being disposed to the dimming pack exactly aligned at the light source; a light outlet surface being disposed at the end of the light guide plate; multiple diffusers being provided on both of the light inlet and the light outlet surface; and the light from the light source being diffused by the dimming pack before entering into the light guide plate for achieving more effective use of the light.

2. The dimming pack of a side-edge backlight module of claim 1, wherein each diffuser is comprised of multiple protrusion each in the form of a polygonal awl.

3. The dimming pack of a side-edge backlight module of claim 1, wherein each diffuser is comprised of multiple pits each in the form of a polygonal awl.

4. The dimming pack of a side-edge backlight module of claim 1, wherein each diffuser is made of multiple protrusions each made in the form of a polygonal awl and directly extending from the diffuser.

5. The dimming pack of a side-edge backlight module of claim 1, wherein each diffuser is made of multiple pits each made in the form of a polygonal awl and directly extending from the diffuser.

6. The dimming pack of a side-edge backlight module of claim 1, wherein each diffuser is made of multiple slots each made in the form of a straight line and directly extending from the diffuser.

7. The dimming pack of a side-edge backlight module of claim 1, wherein multiple hollow members are further disposed in the dimming pack.

8. The dimming pack of a side-edge backlight module of claim 7, wherein those hollow members are arranged in a continuous form.

9. The dimming pack of a side-edge backlight module of claim 7, wherein those hollow members are not arranged in a continuous form.

10. The dimming pack of a side-edge backlight module of claim 1, wherein multiple optical films are disposed over the light guide plate.
